(19) United States
(12) Patent Application Publication
(10) Pub. No.: US 2014/0032855 A1
(43) Pub. Date: Jan. 30, 2014

(54) INFORMATION PROCESSING APPARATUS AND METHOD

(71) Applicant: Fujitsu Limited, Kawasaki-shi (JP)

(72) Inventors: Tatsuya SHINOZAKI, Kawasaki (JP); Nina TSUKAMOTO, Koto (JP); Hidehiko NISHIDA, kawasaki (JP)

(73) Assignee: FUJITSU LIMITED, Kawasaki-shi (JP)

(21) Appl. No.: 13/952,700

(22) Filed: Jul. 29, 2013

(30) Foreign Application Priority Data
Jul. 30, 2012 (JP) 2012-168345

(51) Int. Cl. G06F 12/08

(52) U.S. Cl. CPC G06F 12/0804
USPC 711/142

(57) ABSTRACT

An information processing apparatus includes a processor, a memory, and a cache. Information read from the memory by the processor is stored in the cache. The processor writes the information stored in the memory in all of the regions of the cache at a predetermined timing.

### CROSS-REFERENCE TO RELATED APPLICATION

This application is based upon and claims the benefit of priority of the prior Japanese Patent Application No. 2012-168345, filed on Jul. 30, 2012, the entire contents of which are incorporated herein by reference.

### FIELD

The embodiments discussed herein are related to a method for controlling a cache memory.

### BACKGROUND

Data stored in a cache can be protected with parity. However, for data protection with parity, soft errors caused by the influence of, for example, a neutron can be detected but cannot be corrected. Thus, the system becomes inoperative when a soft error occurs in data stored in a cache. To prevent the system from stopping when a soft error occurs, a method could be used that includes adding an ECC (Error Correction Code) to data stored in a cache. Currently, however, protecting methods with an ECC have rarely been adopted. Some of the reasons are a high bit cost of a cache, performance deterioration of the cache due to an addition of an ECC, a low rate of an occurrence of a soft error, and so on. Accordingly, when a soft error occurs, processing is terminated for that moment and the apparatus is then reset. However, in recent years, in view of a surge in soft error rates associated with finer circuits, soft errors have needed to be addressed.

Cache utilization ratios depend on a program execution ratio. Unlike a DIMM (Dual Inline Memory Module) region, cache regions do not have a refresh function that relies on hardware; unlike a main memory, cache regions cannot be controlled to access a region by directly designating an address. Thus, when the program execution ratio is low, a cache region is present that is not accessed for a long time. Charge refresh is not performed on such a cache region for a long time. The tolerance of a cache to soft errors decreases with time after refresh is performed. Accordingly, when the program execution ratio is low, a cache region is present that is not accessed for a long time, and a soft error easily occurs in such a region.

Whether or not a soft error has occurred is checked in data within a cache when a CPU (Central Processing Unit) accesses a region of the cache in which the data is stored. Thus, the soft error that occurs in the region that has not been accessed for a long time remains after the error occurs without being recognized by the CPU. Thus, as an example, soft errors frequently become apparent as soon as a program execution ratio increases.

This has a great influence on a redundant system. When, for example, a program execution ratio increases simultaneously in two nodes that form the redundant system, a soft error simultaneously becomes apparent for the two nodes even though the soft error occurs at a different time in each of the nodes. When a soft error becomes apparent, the systems become inoperative. Thus, when errors simultaneously become apparent, both of the systems simultaneously stop, thereby disabling a service from being continued.

Specific examples of such a situation include, for example, a situation in which a soft error that began when both systems were in an IDLE state for a long time becomes apparent simultaneously for both of the systems at startup of the systems.

As a method for preventing a soft error that would occur in a particular cache region accessed with a low frequency, a method is known wherein data in one or more cache lines of a cache memory is reread from a main memory and saved in accordance with a result of monitoring of the cache memory.

Technologies described in the following document are known.
Document 1: Japanese Laid-open Patent Publication No. 2010-237739

However, this method protects a cache region accessed by a CPU but does not protect a released cache region or a free cache region.

### SUMMARY

According to an aspect of the embodiment, an apparatus includes a memory, a cache, and a processor. The memory is configured to store information. The cache includes a function that is different from a function of the memory. The processor is configured to write the information read from the memory in all regions of the cache at a predetermined timing.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates an exemplary configuration of an information processing apparatus in accordance with the embodiment.

FIG. 2 illustrates an exemplary configuration of an information processing system in accordance with the embodiment.

FIG. 3 illustrates a situation in which a CPU accesses a main memory via an L1 cache and an L2 cache.

FIG. 4 illustrates a situation in which a not-accessed region is generated in a cache.

FIG. 5 illustrates the entire flow of a process in accordance with the embodiment.

FIG. 6 illustrates a processing method for causing a cache miss in a 2-way set associative scheme in accordance with a first embodiment.

FIG. 7 illustrates a flow diagram of detailed processes of generating a cache miss in a 2-way set associative scheme in accordance with the first embodiment.

FIG. 8 illustrates a flow diagram of detailed processes of generating a cache miss in a 2-way set associative scheme in accordance with a second embodiment.

FIG. 9 illustrates a flow diagram of detailed processes of generating a cache miss in a 2-way set associative scheme in accordance with a third embodiment.

### DESCRIPTION OF EMBODIMENTS

Preferred embodiments of the present invention will be explained with reference to accompanying drawings.

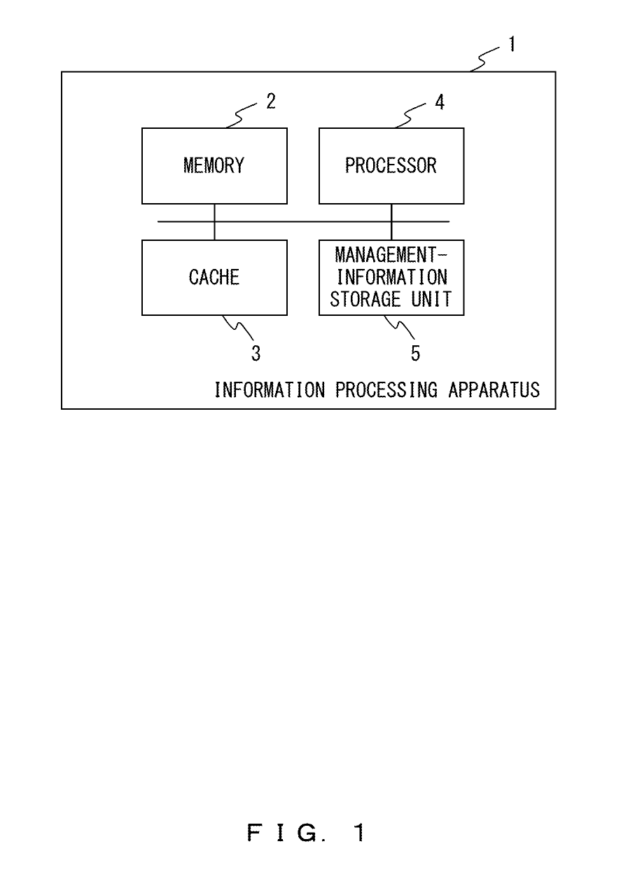

FIG. 1 illustrates an exemplary configuration of an information processing apparatus in accordance with the embodiment.

An information processing apparatus 1 includes a memory 2, a cache 3, a processor 4, and a management-information storage unit 5. The cache 3 has a function that is different from that of the memory 2. The processor 4 writes information stored in the memory 2 in all of the regions of the cache 3 at a predetermined timing. The processor 4 also determines an activity ratio of the processor 4. In accordance with the result of determining, the processor 4 writes information stored in the memory 2 in all of the regions of the cache 3. The management-information storage unit 5 stores address information of the memory 2 that corresponds to data stored in the cache 3.

### First Embodiment

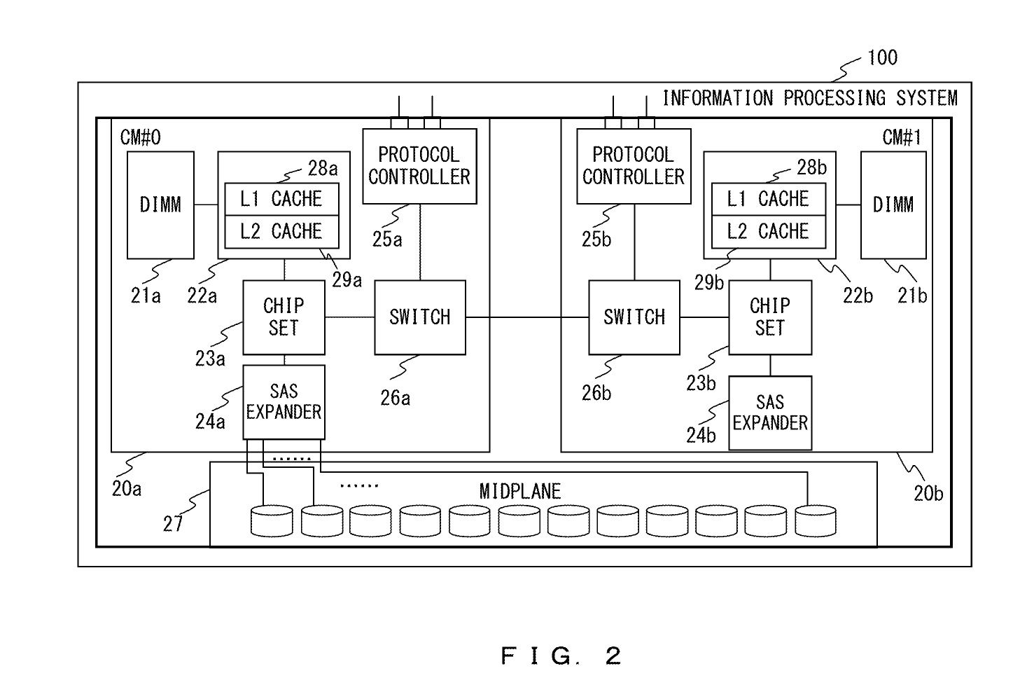

FIG. 2 illustrates an exemplary configuration of an information processing system in accordance with the embodiment. Taking advantage of software locality, an information processing system 100 combines a low-speed and high-capacity main memory with a high-speed and low-capacity cache memory so as to enhance a processing capacity of a CPU. Basically, the CPU addresses only the cache memory as an object to be accessed (an object from which data is read and to which data is written).

The information processing system 100 includes a CM (Controller Module) #0 (CM 20a) and a CM #1 (CM 20b), which are configured to be mutually redundant. Both the CMs 20a and 20b will hereinafter be simply referred to as a CM 20. Each element that forms the CM 20 will also be expressed in the same manner. As an example, both CPUs 22a and 22b will simply be referred to as a CPU 22. The CM 20 is connected to an auxiliary storage apparatus located on a midplane 27.

The CM 20 includes a DIMM 21, a CPU 22, a chip set 23, an SAS expander 24, a protocol controller 25, and a switch 26.

The CPU 22 is connected to an auxiliary storage apparatus located on the midplane 27 via the chip set 23 and the SAS (Serial Attached SCSI, SCSI: Small Computer System Interface) expander 24. The CPU 22 is also connected to the protocol controller 25 via the chip set 23 and the switch 26, and the protocol controller 25 is connected to an external apparatus. The protocol controller 25 controls data transmitted to or received from an external apparatus by the CM 20. In addition, the CMs #0 and #1, which are connected to each other via the switch 26, exchange information for redundancy.

The CPU 22 includes an L1 cache 28 and an L2 cache 29. The CPU 22 is connected to the DIMM 21 via the L1 cache 28 and the L2 cache 29. To access data within the DIMM 21, the CPU 22 reads from the DIMM 21 the data to be accessed, loads this data into the L1 cache 28 or the L2 cache 29, and accesses this data.

The L1 cache 28 is a high-speed and low-capacity cache memory from which the CPU 22 initially attempts to read data. The L1 cache 28 stores data that is used by the CPU 22 with a high frequency.

The L2 cache 29 is a cache memory accessed when the CPU 22 attempts to read data from the L1 cache 28 but find no data within the L1 cache 28. The L2 cache 29 is slow and has a high capacity in comparison with the L1 cache 28, but is fast and has a low capacity in comparison with the main memory.

The DIMM 21, which is a memory module formed of a plurality of DRAMs (Dynamic Random Access Memory) provided on a substrate, is used as a main memory. The CPU 22 transfers data between the DIMM 21 and an auxiliary storage apparatus connected via the SAS expander 24. The DIMM 21 may hereinafter be referred to as a main memory 21.

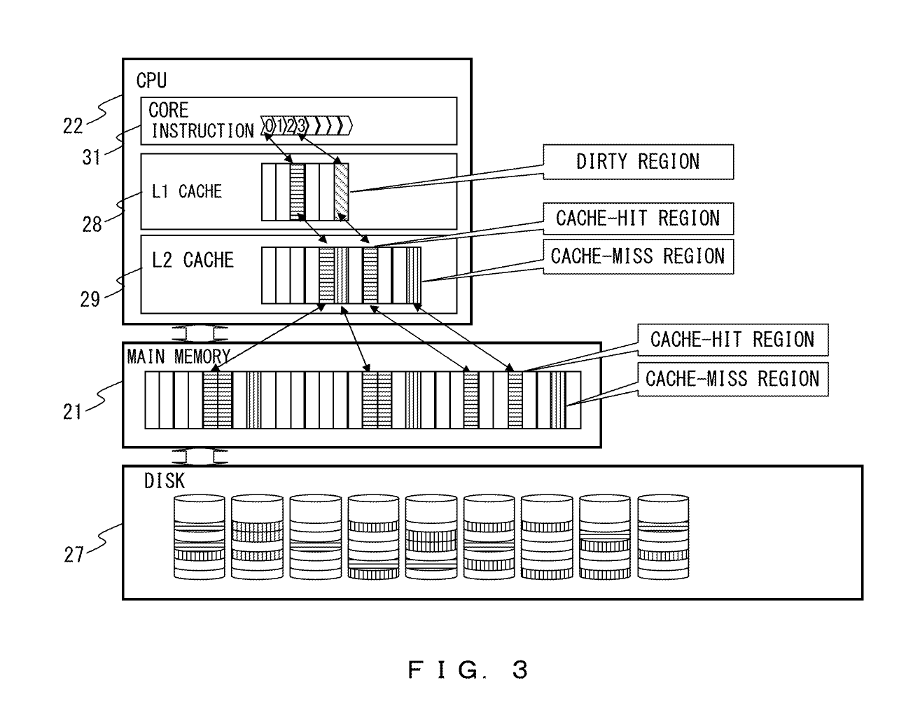

FIG. 3 illustrates a situation in which the CPU 22 accesses the main memory 21 via the L1 cache 28 and the L2 cache 29. A core 31 of the CPU 22 accesses pieces of data which are each used for an instruction. In accessing data, the CPU 22 first determines whether or not target data is stored in the L1 cache 28. When the data is stored in the L1 cache 28, the CPU 22 accesses and processes this data. When the target data is not stored in the L1 cache 28, the CPU 22 checks the content of the L2 cache 29 so as to determine whether or not the target data is stored. When the target data is stored in the L2 cache 29, the CPU 22 accesses and processes this data. When the target data is also not present in the L2 cache 29, the CPU 22 reads and loads into the L2 cache 29 a content of the main memory 21 that is an object to be accessed, and accesses this read data. Both the L1 cache 28 and the L2 cache 29 may hereinafter be simply referred to as a cache.

Data is transferred between the main memory 21 and the cache for each cache line of a predetermined number of bytes (e.g., 64 bytes). The cache lines, which are unit cache regions having a predetermined size, are each associated with a plurality of predetermined addresses of the main memory 21.

When access to the main memory 21 occurs, the CPU 22 determines whether or not data to be accessed is stored in a cache line that corresponds to an address to be accessed. When the data is stored in the cache line (cache hit), the CPU 22 accesses the stored data. When the data is not stored in the cache line (cache miss), the CPU 22 reads target data from the main memory 21 and loads this target data into the cache line (cache fill), and accesses this target data.

The cache has a FIFO (First In First Out) processing queue to receive access requests from the CPU 22, and performs processes stored in the processing queue in order.

In the case of a writeback-type cache memory, when write data from the CPU 22 is present in a cache memory, only data within the cache is rewritten, and data within the main memory 21 is rewritten afterwards. Rewriting is performed, for example, when a certain line is abolished for cache fill or when a bus master that is not the CPU 22 accesses data. In such a scheme, cache data and data within the main memory 21 may temporarily have different contents. A cache line having data that is not identical with data within the main memory 21 is hereinafter referred to as a “dirty line (dirty region)”.

The CMs 20a and 20b are examples of the information processing apparatus 1. The CPU 22 includes the processor 4. The DIMM 21 is an example of the memory 2. The L1 cache 28 and the L2 cache 29 are examples of the cache 3.

Next, an exemplary configuration of the cache will be described in detail. The cache includes a data array that stores data and a tag array that stores management information. The tag array is an example of the management-information storage unit 5.

The tag array that stores management information stores an index, tag information, a status, and a valid bit for each cache line. The index, which indicates an address of a cache line, corresponds to a plurality of low-order bits of the addresses of the main memory 21 that correspond to the cache line. The tag information is information of a plurality of high-order bits of an address at the main memory 21 of data stored in the cache line. The combination of a plurality of low-order bits corresponding to an index and a plurality of high-order bits of tag information indicates the entire address of the main memory 21. The status is information indicating whether or not the content of a cache line obtained from the main memory 21 has been rewritten. The valid bit is information indicating whether a cache line is valid or invalid. For example, a valid bit of “1” is set when data within a corresponding cache line is valid, and a valid bit of “0” is set when data within a corresponding cache line is invalid.

A data array, in which data is stored, stores data stored in the main memory 21 for each cache line corresponding to an index.

Next, descriptions will be given of the flow of access from the CPU 22 to the main memory 21 in a writeback scheme.

When access occurs from the CPU 22 to the main memory 21, the CPU 22 first compares a low-order bit of a request address with an address of an index and then determines a cache line corresponding to a matched comparison result. For the cache line having an index that matches the low-order bit of the request address, the CPU 22 compares tag information with a high-order bit of the request address; when the comparison result matches, the CPU 22 determines that a cache hit has occurred and obtains data of the cache line. Accordingly, the CPU 22 accesses the data to be accessed.

Meanwhile, when the tag information does not match the high-order bit of the request address, the CPU 22 determines that a cache miss has occurred and reads and loads, into a cache line, data at an address of the main memory 21 to be accessed. Then, the CPU 22 obtains the data that has been read and loaded into the cache line. In this way, the CPU 22 accesses the data to be accessed.

For access for which a cache hit has occurred, when the access is a write access, data within the cache is rewritten, so the cache line is regarded as being a dirty line. In this case, the CPU 22 rewrites information of a data array that corresponds to a cache line to be accessed and changes the value of the status to indicate that the content has been rewritten. Subsequently, when, for example, a new access to the dirty line occurs and a cache fill occurs, data stored in the dirty line is written to the main memory 21.

Next, a flow of the process will be described.

When a program is frequently operated, the CPU 22 accesses a cache with a high frequency. It is checked whether or not a soft error has occurred in the cache at a moment when the CPU 22 accesses a region, so the time period between an occurrence of the soft error and detection of the soft error becomes short if access occurs frequently. In this case, an error check is frequently conducted, so, in a redundant system, it is highly likely that a soft error that occurs in one node will be detected before a soft error occurs in another node. Accordingly, when the program is frequently operated, an occurrence of a soft error has only a small influence on the entire system.

Meanwhile, under a condition in which the program is seldom operated or in which the program is frequently operated, some cache regions are also not accessed for a long time when only data of the same address is frequently accessed. An attempt is not made for a long time to detect a soft error in such a region, so the soft error may possibly remain in this region.

When a cache miss seldom occurs, data within some cache regions are not replaced for a long time. Electric charges within these regions are not refreshed for a long time, thereby increasing the likelihood of an occurrence of a soft error.

This is also true for released cache regions or cache regions that have never been used after the CM 20 has been turned on. Data stored in these regions are not used, but it is checked whether or not a soft error has occurred in these regions next time the CPU 22 accesses these regions. When a soft error occurs on data stored in a released cache region or in a cache region that has never been used after the power has been turned on, the CPU 22 detects the error during an access operation, so the system is stopped.

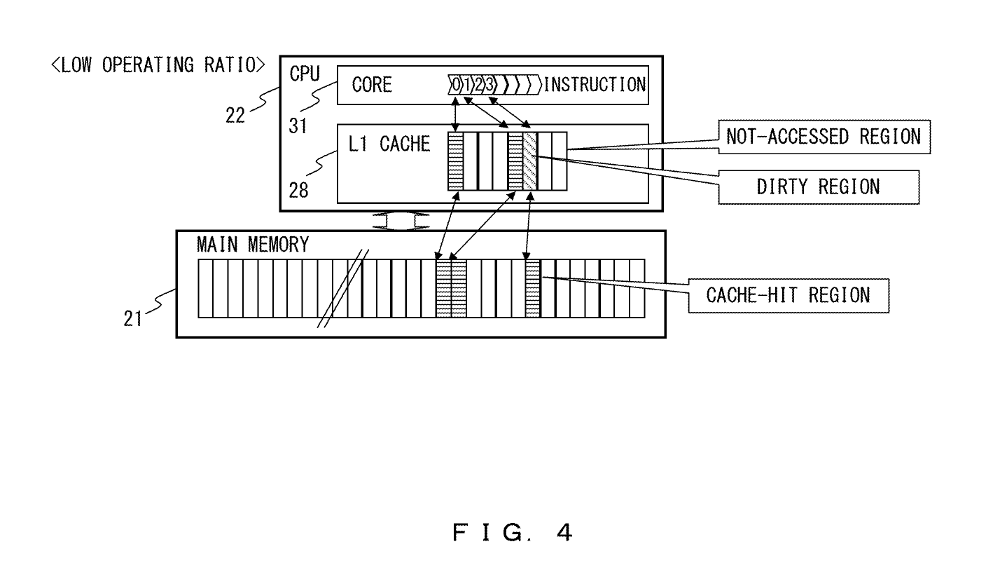

FIG. 4 illustrates a situation in which a not-accessed region is generated in a cache. When the operating ratio of the system is low, the cache regions include a not-accessed region, which is not used by the CPU 22.

Accordingly, in the present embodiment, when the CPU 22 does not satisfy a predetermined activity ratio, the CPU 22 periodically performs a process of rewriting data within all of the cache regions so as to write data within the main memory 21 into the cache regions. In particular, for example, the CPU 22 executes once a week a predetermined program set to cause the CPU 22 to temporarily create a busy state, thereby filling up the cache processing queue. Accordingly, the CPU 22 puts all of the cache regions in use and forcibly replaces data within all of the cache regions with data stored in the main memory 21. The regions for which data is forcibly replaced include a released cache region or a region that has never been used after the CM 20 has been turned on. Any program may be used as the predetermined program set, as long as it allows a process of rewriting data within all of the cache regions to be performed so as to write data within the main memory 21 into the cache regions.

The program set needs to be periodically executed, but a soft error occurs at, for example, a frequency of less than 1000 Fit (Failures-In-Time), so executing the program set once a week, for example, is sufficient to prevent a soft error.

With reference to a redundant configuration, even when a soft error occurs in a plurality of apparatuses that form the redundant configuration, the program set is periodically executed at different times for each of the apparatuses that form the redundant configuration, so that the apparatuses can be prevented from simultaneously going down. In the present embodiment, the program set is executed by the CMs 20a and 20b at different times so that the CMs 20a and 20b can be prevented from simultaneously going down.

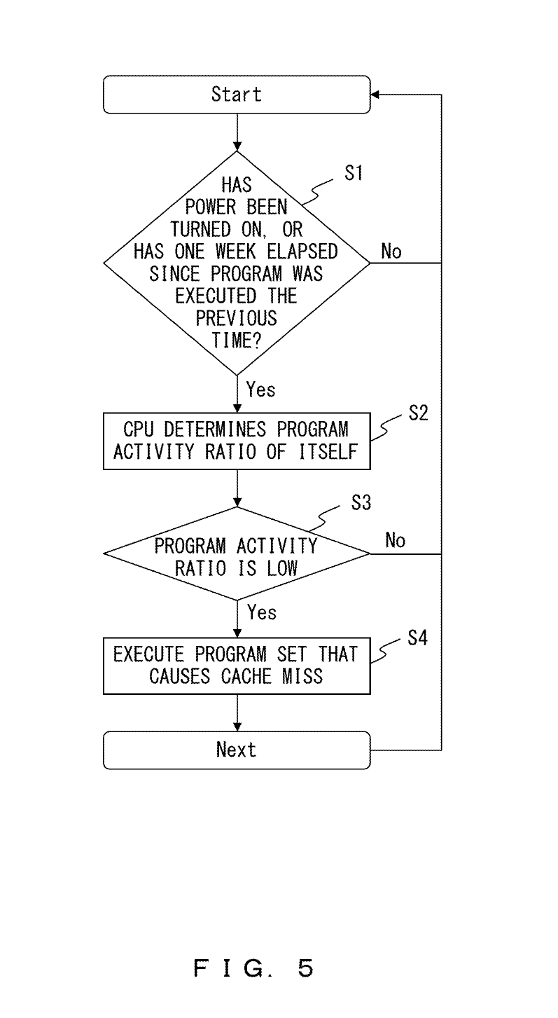

Next, descriptions will be given of the entire flow of a process in accordance with the present embodiment. FIG. 5 illustrates the entire flow of a process in accordance with the present embodiment.

The CPU 22 determines whether or not the CM 20 has been turned on just before and whether or not one week has elapsed since a program that causes a cache miss was executed the previous time (S1). When the CM 20 has been turned on just before or when one week has elapsed since the program that causes a cache miss was executed the previous time (Yes in S1), the CPU 22 determines a program activity ratio of the CPU 22 (S2). When the CM 20 has not been turned on just before and one week has not elapsed since the program set that causes a cache miss was executed the previous time (No in S1), the process returns to S1. When the CPU 22 determines in S2 that the program activity ratio is low (Yes in S3), the CPU 22 executes the program set that causes a cache miss (S4). When the CPU 22 determines in S2 that the program activity ratio is high (No in S3), the process returns to S1. When the CPU 22 executes in S4 the program set that causes a cache miss, the process return to S1.

S1 includes, as one branch condition of the process, determining whether or not one week has elapsed since the program that caused a cache miss was executed the previous time, but the condition on the time that elapses after the program that was executed is not limited to one week. The determination in S1 as to whether or not the CM 20 was turned on just before may be made by determining whether or not the period of elapsed time after the CM 20 has been turned on is within a predetermined time period.

Next, descriptions will be given of a process by the program that causes a cache miss.

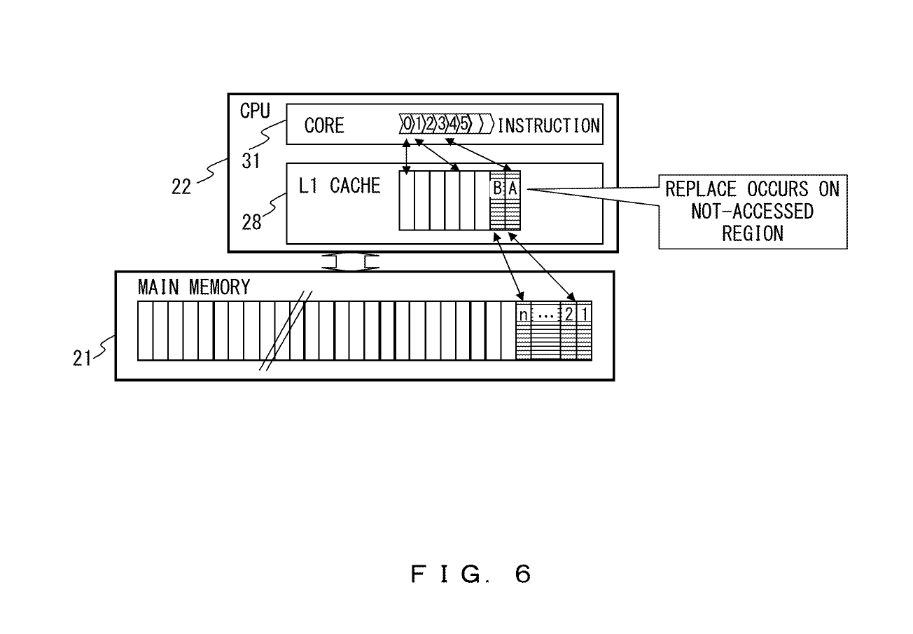

As a simple example, a processing method for causing a cache miss in a 2-way set associative scheme will be described in the following. FIG. 6 illustrates a processing method for causing a cache miss in a 2-way set associative scheme in accordance with a first embodiment. For the sake of description, FIG. 4 and FIG. 6 illustrate a situation in which the CPU 22 includes only the L1 cache 28, but the CPU 22 may include the L2 cache 29. The CM 20 in accordance with the present embodiment may include a cache with a multistage configuration such that the CPU 22 includes an L3 cache, (an L4 cache, . . . ). The LRU (Least Recently Used) algorithm is used to select from two ways a way for which data is to be replaced. The LRU algorithm is a scheme wherein data that has not been referenced for the longest time from among data stored in two ways is selected as an object to be replaced.

In the 2-way set associative scheme, cache lines of the L1 cache 28 are each associated with a particular address of the main memory 21. When the number of ways is two, the corresponding two ways correspond to the same address of the main memory 21. Referring to, for example, FIG. 6, ways A and B of the L1 cache 28 are associated with addresses 1 to n of the main memory 21. Ways A and B are associated with the same addresses (1 to n) of the main memory 21 (a cache having a two-way configuration).

Accordingly, in the case of the example of FIG. 6, when an access occurs to four different addresses from among the addresses of the main memory 21 that correspond to ways A and B (1 to n), data within the main memory 21 is written to both ways A and B. Accessing all of the cache lines of the L1 cache 28 allows data within all of the cache regions to be rewritten.

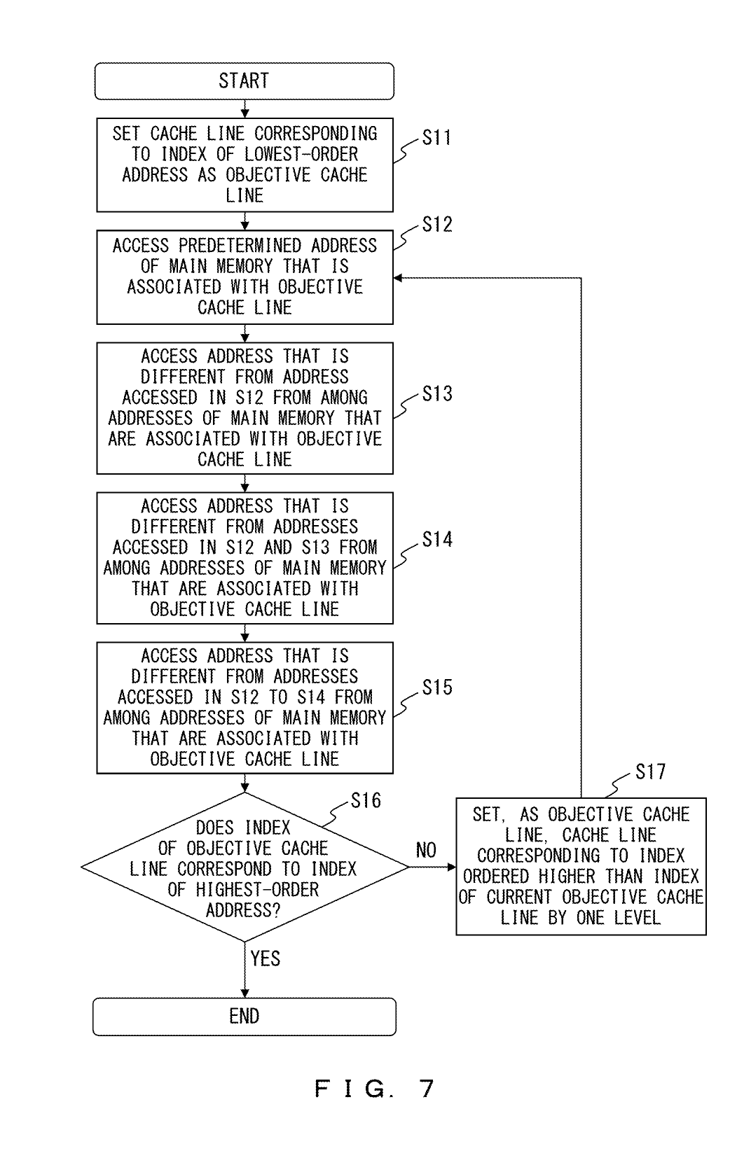

FIG. 7 illustrates a flow diagram of detailed processes of generating a cache miss in a 2-way set associative scheme in accordance with the first embodiment. In this example, the LRU algorithm is used as an algorithm to select, from two ways, one way for which data is to be replaced.

First, the CPU 22 sets a cache line corresponding to an index of the lowest-order address as an objective cache line (S11).

Next, the CPU 22 accesses a predetermined address from among addresses of the main memory 21 that are associated with the objective cache line (S12). When the access causes a cache miss, the CPU 22 replaces the data within the cache line with data at the address of the main memory 21 to be accessed. Then, the CPU 22 accesses the data within the cache line that has been rewritten. When the access of S12 leads to a cache hit, the CPU 22 accesses the data that has already been stored in the cache line. In this case, the data within the cache line is not replaced with the data within the main memory 21.

Next, the CPU 22 accesses an address that is different from the address accessed in S12 from among the addresses of the main memory 21 that are associated with the objective cache line (S13). When the access causes a cache miss, the CPU 22 replaces the data within the cache line with data at the address to be accessed of the main memory 21. Then, the CPU 22 accesses the data within the cache line that has been rewritten. When the access of S13 results in a cache hit, the CPU 22 accesses the data that has already been stored in the cache line. In this case, the data within the cache line is not replaced with data within the main memory 21.

In the present embodiment, the LRU algorithm is adopted as a replacement scheme for the cache, so the CPU 22 accesses the way of the cache line that is different from the way that is accessed by the CPU 22 in S12.

Next, the CPU 22 accesses an address that is different from both of the addresses accessed in S12 and S13 from among the addresses of the main memory 21 that are associated with the objective cache line (S14). When the number of ways is two, a cache hit does not occur in the access of S14, so the CPU 22 replaces data within the cache line with the data at the address to be accessed of the main memory 21. Then, the CPU 22 accesses the data within the cache line that has been rewritten. In this case, the CPU 22 accesses the way of the cache line that is the same as the way that is accessed by the CPU 22 in S12.

Next, the CPU 22 accesses an address that is different from all of the addresses read in S12, S13, and S14 from among the addresses of the main memory 21 that are associated with the objective address (S15). When the number of ways is two, a cache hit does not occur in the access of S14, so the CPU 22 replaces data within the cache line with the data at the address to be accessed of the main memory 21. Then, the CPU 22 accesses the data within the cache line that has been rewritten. In this case, the CPU 22 accesses the way of the cache line that is the same as the way that is accessed by the CPU 22 in S13.

Then, the CPU 22 determines whether or not the address of the objective cache line corresponds to an index of the highest-order address (S16). When it does correspond to the highest-order address (Yes in S16), the process ends. When it does not correspond to the highest-order address (No in S16), the CPU 22 sets, as an objective address, a cache line corresponding to the index ordered higher than the address of the current objective index by one level (S17). The process then returns to S12.

In the case of an increased number of ways, the number of times the CPU 22 accesses different pieces of data within the main memory 21 that are associated with an objective cache line may be increased in accordance with the increase in the number of ways. For two ways, the CPU 22 accesses four different addresses of the main memory 21 that are associated with the objective cache line. By contrast, for four ways, the CPU 22 may access eight different addresses of the main memory 21 that are associated with the objective cache line.

### Second Embodiment

As with the entire flow of the process in accordance with the first embodiment, the entire flow of a process in accordance with a second embodiment is illustrated in FIG. 5. In regard to the program that causes a cache miss in S4 of FIG. 5, in the second embodiment, even when a cache miss occurs, a process is performed of replacing data within a cache with data within the main memory 21.

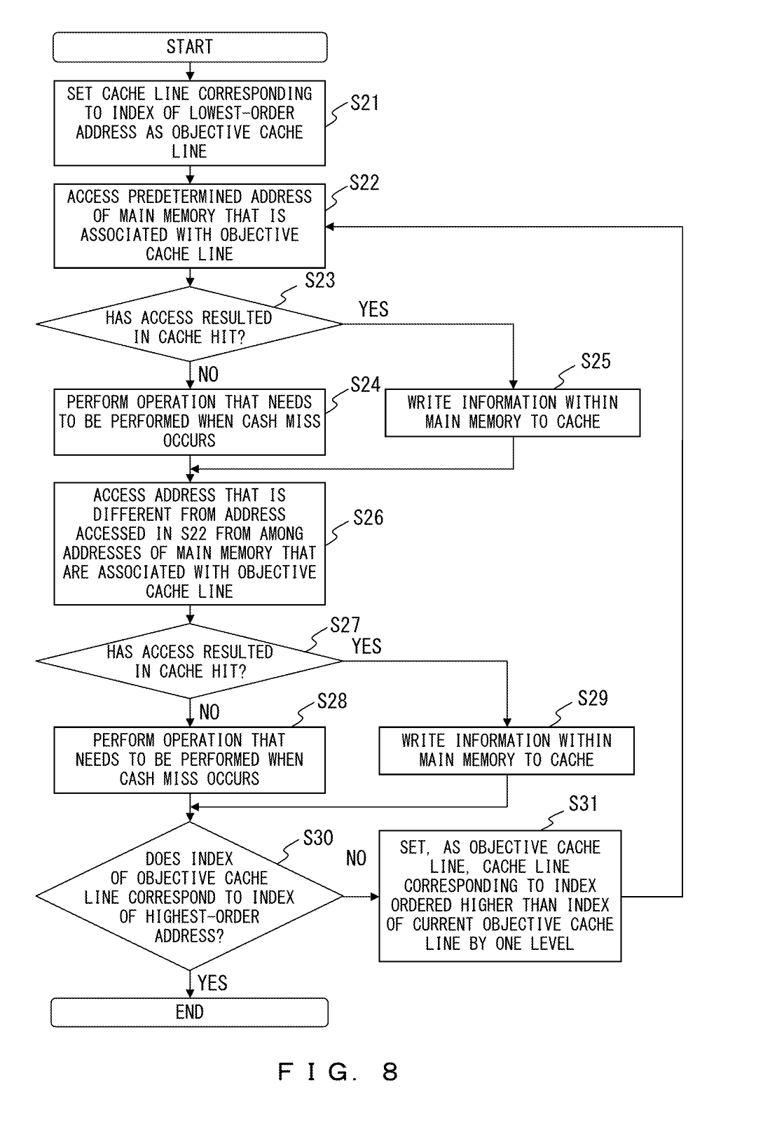

FIG. 8 illustrates a flow diagram of processes of generating a cache miss in a 2-way set associative scheme in accordance with the second embodiment. In this example, the LRU algorithm is used to select from two ways a way for which data is to be replaced.

First, the CPU 22 sets a cache line corresponding to an index of the lowest-order address as an objective cache line (S21).

Next, the CPU 22 accesses a predetermined address from among addresses of the main memory 21 that are associated with the objective cache line (S22).

Subsequently, the CPU 22 determines whether or not the access of S22 has resulted in a cache hit (S23).

When the access has not resulted in a cache hit, i.e., when a cache miss has occurred (No in S23), the CPU 22 performs the operation that needs to be performed when a cache miss occurs (S24). That is, the CPU 22 replaces data within the cache line with data at the address to be accessed of the main memory 21. Then, the CPU 22 accesses the rewritten data within the cache line, shifting the process to S26.

When the access of S23 has resulted in a cache hit (Yes in S23), the CPU 22 replaces the data within the cache line with data at the address to be accessed of the main memory 21 (S25). In this case, although the data to be accessed has already been present in the cache, the CPU 22 again reads and loads data from the main memory 21 into the cache line.

Next, the CPU 22 accesses an address that is different from the address accessed in S22 from among the addresses of the main memory 21 that are associated with the objective cache line (S26).

Subsequently, the CPU 22 determines whether or not the access of S26 has resulted in a cache hit (S27).

When the access has resulted in a cache miss (No in S27), the CPU 22 performs the operation that needs to be performed when a cache miss occurs (S28). That is, the CPU 22 replaces the data within the cache line with data at the accessed address of the main memory 21. Then, the CPU 22 accesses the rewritten data within the cache line, shifting the process to S30.

When the access of S27 has resulted in a cache hit (Yes in S27), the CPU 22 replaces the data within the cache line with data at the address to be accessed of the main memory 21 (S29). In this case, even though the data to be accessed has already been present in the cache, the CPU 22 again reads and loads data from the main memory 21 into the cache line, as in the case of the operation of S25. Note that the data written to the cache line in S29 may be data at a predetermined address of the main memory 21.

Then, the CPU 22 determines whether or not the address of the objective cache line corresponds to an index of the highest-order address (S30). When it does correspond to the highest-order address (Yes in S30), the process ends. When it does not correspond to the highest-order address (No in S30), the CPU 22 sets, as an objective address, a cache line corresponding to the index ordered higher than the address of the current objective index by one level (S31). The process then returns to S22.

### Third Embodiment

As with the entire flow of the process in accordance with the first and second embodiments, the entire flow of a process in accordance with a third embodiment is illustrated in FIG. 5. In regard to the program that causes a cache miss in S4 of FIG. 5, in the third embodiment, the CPU 22 accesses the main memory 21 in a manner such that a cache miss is definitely caused using information of a tag array of the cache.

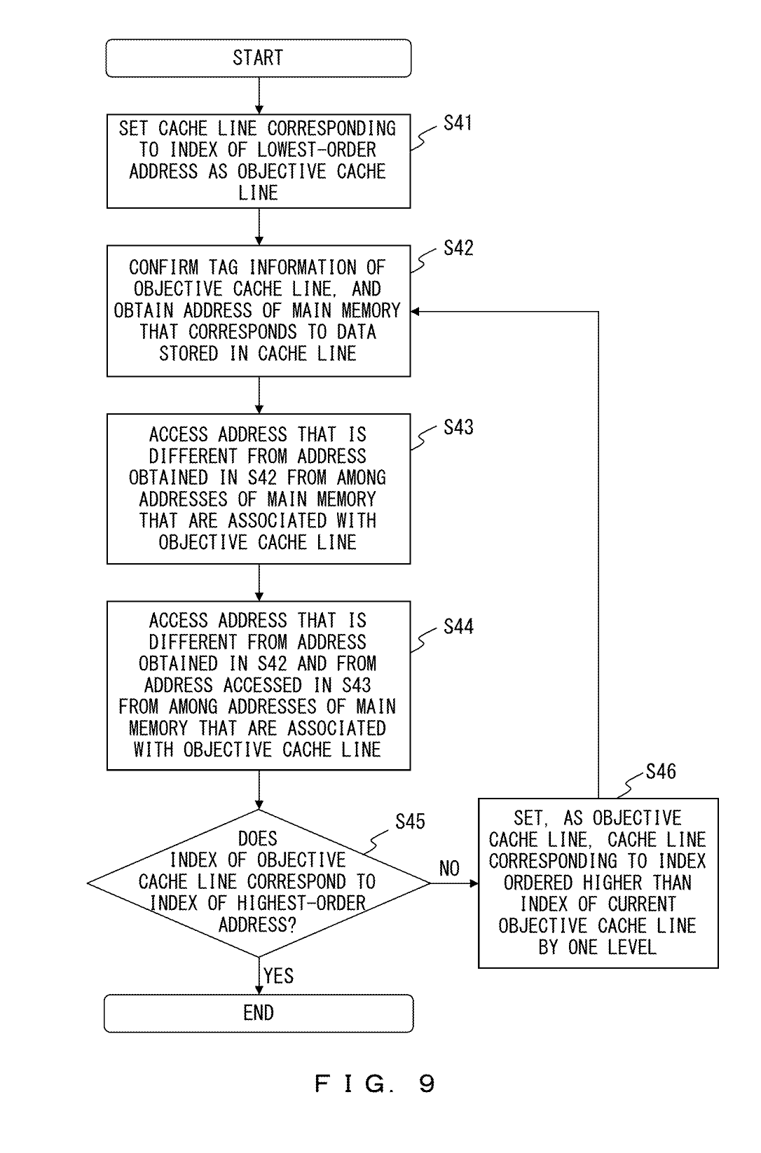

FIG. 9 illustrates a flow diagram of processes of generating a cache miss in a 2-way set associative scheme in accordance with the third embodiment. In this example, the LRU algorithm is used to select from two ways a way for which data is to be replaced.

First, the CPU 22 sets a cache line corresponding to an index of the lowest-order address as an objective cache line (S41).

Next, the CPU 22 references tag information of a tag array of the two current objective ways, and determines which address of the main memory 21 data currently stored in the cache line corresponds to (S42).

Subsequently, the CPU 22 accesses an address of the main memory 21 that is different from the address determined in S42 from among the addresses of the main memory 21 that are associated with the objective cache line. The accessing definitely causes a cache miss, so the CPU 22 replaces the data within the objective cache line with the data at the address to be accessed of the main memory 21 (S43). Then, the CPU 22 accesses the rewritten data within the cache line.

In addition, the CPU 22 accesses an address of the main memory 21 that is different from the address determined in S42 and from the address accessed in S43 from among the addresses of the main memory 21 that are associated with the objective cache line. The accessing definitely causes a cache miss, so the CPU 22 replaces the data within the objective cache line with the data at the address to be accessed of the main memory 21 (S44). Then, the CPU 22 accesses the rewritten data within the cache line.

Then, the CPU 22 determines whether or not the address of the objective cache line corresponds to an index of the highest-order address (S45). When it does correspond to the highest-order address (Yes in S45), the process ends. When it does not correspond to the highest-order address (No in S45), the CPU 22 sets, as an objective address, a cache line corresponding to the index ordered higher than the address of the current objective index by one level (S46). The process then returns to S42.

The present embodiment is not limited to the aforementioned embodiments, and various configurations or embodiments can be achieved without departing from the spirit of the present embodiment.

The present embodiment may decrease the likelihood of an occurrence of a soft error in a cache.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store information;
a cache including a function that is different from a function of the memory; and
a processor configured to write the information read from the memory in all regions of the cache at a predetermined timing.

2. The information processing apparatus according to claim 1, wherein
when a cache hit occurs, the processor writes the information read from the memory in a region of the cache in which data that corresponds to the cache hit is stored.

3. The information processing apparatus according to claim 1, the information processing apparatus further comprising:
a management-information storage unit configured to store address information of the memory that corresponds to data stored in the cache, wherein
by using the address information, the processor accesses all of the regions of the cache so as to cause a cache miss at a predetermined timing.

4. The information processing apparatus according to claim 1, wherein
the processor writes the information read from the memory in all of the regions of the cache at predetermined time intervals or at startup of the information processing apparatus.

5. The information processing apparatus according to claim 1, wherein
the processor writes the information read from the memory in all of the regions of the cache at a timing that is different from a timing for another information processing apparatus that forms a redundant system together with the information processing apparatus.

6. The information processing apparatus according to claim 1, wherein
the processor determines an activity ratio of the processor and, in accordance with a result of the determining, writes the information read from the memory in all of the regions of the cache.

7. A computer-readable recording medium having stored therein a program for causing a computer to execute a process comprising:
writing information read from a memory in all regions of a cache at a predetermined timing, the cache including a function that is different from a function of the memory.

8. The computer-readable recording medium according to claim 7, wherein
when a cache hit occurs, the writing writes the information read from the memory in a region of the cache in which data that corresponds to the cache hit is stored.

9. The computer-readable recording medium according to claim 7, wherein
the writing accessing all of the regions of the cache so as to cause a cache miss at a predetermined timing by using address information of the memory that corresponds to data stored in the cache.

10. The computer-readable recording medium according to claim 7, wherein
the writing writes the information read from the memory in all of the regions of the cache at predetermined time intervals or at startup of an information processing apparatus that includes the computer.

11. The computer-readable recording medium according to claim 7, wherein
the writing writes the information read from the memory in all of the regions of the cache at a timing that is different from the timing for an information processing apparatus that forms a redundant system together with an information processing apparatus that includes the computer.

12. The computer-readable recording medium according to claim 7, the process further comprising:
determining an activity ratio of the processor and, in accordance with a result of the determining, writing the information read from the memory in all of the regions of the cache.

13. An information processing method performed by a computer, the information processing method comprising:
writing information read from a memory in all regions of a cache at a predetermined timing by using the computer, the cache including a function that is different from a function of the memory.
